(19) United States
(12) Patent Application Publication
(10) Pub. No.: US 2010/0014219 A1
(43) Pub. Date: Jan. 21, 2010

(54) Explosive Atmosphere Heat Dissipation System

(76) Inventors: Julien Strack, Champigny (FR); Lucas Teurlay, Amiens (FR); Dominique Aubry, Hallencourt (FR); Stephane Breard, Oust-Marest (FR)

Correspondence Address: SCHLUMBERGER IPC;ATTN: David Cate, 555 INDUSTRIAL BOULEVARD, MD-21, SUGAR LAND, TX, 77478, US

(21) Appl. No.: 12/423,853

(22) Filed: Apr. 15, 2009

Related U.S. Application Data
(60) Provisional application No. 61/045,029, filed on Apr. 15, 2008.

(51) Int. Cl. H02B 1/56

(52) U.S. Cl. 361/677

(57) ABSTRACT

An embodiment of a system to dissipate heat from electric equipment disposed in an explosive atmosphere comprises at least one electric device disposed in an explosive atmosphere, and a cooling system operable to remove heat from the at least one electric device to cool the at least one electric device to a predetermined temperature.

### CROSS-REFERENCE TO RELATED APPLICATION

This application is entitled to the benefit of, and claims priority to, provisional patent application 61/045,029 filed Apr. 15, 2008, the entire disclosure of which is incorporated herein by reference.

### BACKGROUND

The statements in this section merely provide background information related to the present disclosure and may not constitute prior art. The system and method relate in general to offshore oilfield equipment such as, but not limited to, offshore platforms and oilfield support vessels, such as well stimulation vessels and equipment.

The system and method is related in general to braking resistors for electrical motors and, in particular, to a system and apparatus to dissipate heat from electric power equipment in an explosive atmosphere.

It is desirable, therefore, to provide a cooling system and/or apparatus to dissipate heat from electric power equipment in an explosive atmosphere.

### SUMMARY

An embodiment of a system to dissipate heat from electric equipment disposed in an explosive atmosphere comprises at least one electric device disposed in an explosive atmosphere, and a cooling system operable to remove heat from the at least one electric device to cool the at least one electric device to a predetermined temperature. Alternatively, the at least one electric device is an electric motor/generator coupled to a braking resistor. The electric motor/generator may be coupled to a braking resistor via a variable speed drive and braking chopper. Alternatively, the cooling system comprises a cooling medium for removing heat from the electric device and a heat exchanger. The cooling medium may comprise a liquid cooling system and the heat exchanger may comprise an air-cooled radiator for cooling the liquid. The cooling medium may comprise a gas cooling system and a refrigeration device for cooling the gas. Alternatively, the predetermined temperature is determined by an ignition point of at least one explosive substance. Alternatively, the predetermined temperature is a surface temperature of the electric device. Alternatively, the predetermined temperature is an ATEX Zone II temperature.

In an embodiment, a system to dissipate heat from equipment in an explosive atmosphere comprises at least one device generating a source of heat and disposed in an explosive atmosphere, and a cooling system operable to remove heat from the at least one device such that an exterior surface of the at least one device is cooled to a predetermined temperature. Alternatively, the cooling system comprises a cooling medium for removing heat from the electric device and a heat exchanger. The cooling medium may comprise a liquid cooling system and the heat exchanger may comprise an air-cooled radiator for cooling the liquid. The cooling medium may comprise a gas cooling system and a refrigeration device for cooling the gas. Alternatively, the predetermined temperature is determined by an ignition point of at least one explosive substance.

In an embodiment, a system to dissipate heat from an electric winch drive for wellbore cables, the winch drive disposed in an explosive atmosphere, comprises an electric motor/generator in communication with a source of electrical power and a braking resistor coupled to the electric motor/generator, the motor/generator and the resistor disposed in an explosive atmosphere, and a cooling system operable to remove heat from the braking resistor such that an exterior surface of the resistor is cooled to a predetermined temperature. Alternatively, the electric/motor generator is coupled to and controls a wireline winch having a wireline cable disposed thereon. The system may further comprise a tool attached to the wireline cable for performing at least one wellbore operation. Alternatively, the cooling system comprises a cooling medium for removing heat from the electric device and a heat exchanger. The cooling medium may comprise a liquid cooling system and the heat exchanger may comprise an air-cooled radiator for cooling the liquid. The cooling medium may comprise a gas cooling system and a refrigeration device for cooling the gas.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic block diagram of an electrical motor/generator system.

FIG. 2 is a schematic block diagram of an embodiment of a heat dissipation system.

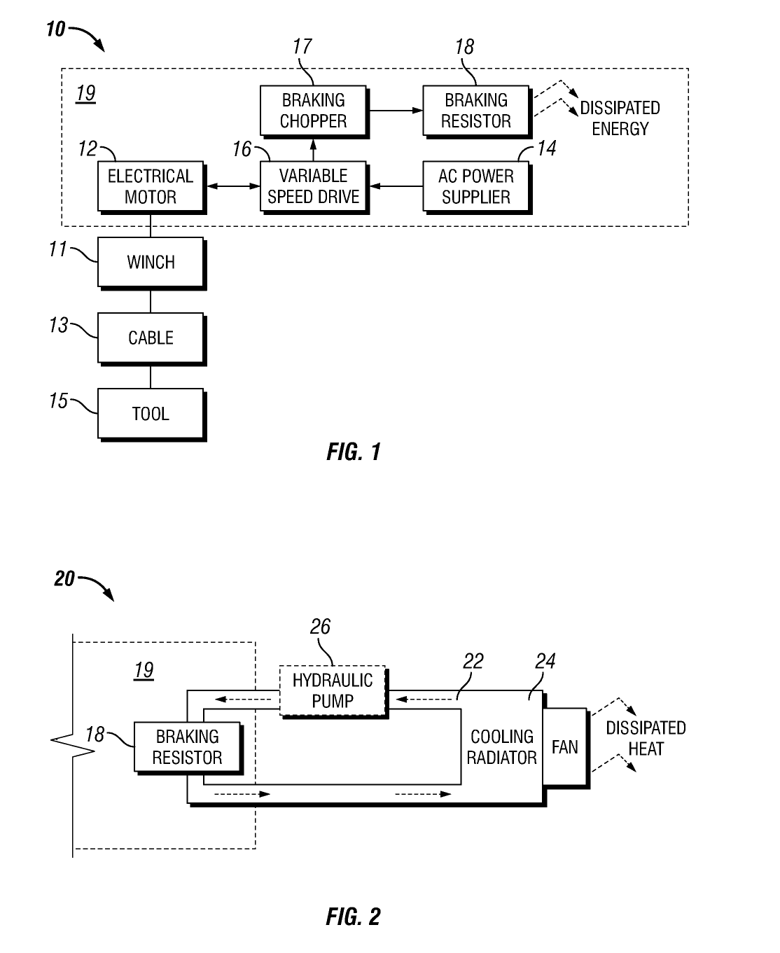

### DETAILED DESCRIPTION

Referring to all of the figures, an embodiment of an electrical system is indicated generally at 10. The system 10 includes an electrical motor 12, which supplies energy to a winch or drum 11 to which is attached to or spooled upon, for example, a wireline logging cable 13 (not shown), as will be appreciated by those skilled in the art. The electric motor 12 receives electric power from a power supply 14 (for example, an alternating current (AC) power supply) through a variable speed drive 16. The cable 13 is spooled on and/or unspooled from the drum # into a wellbore (not shown) due to gravity, drill pipe action, or the like, in accordance with a wellbore operation sequence. The wellbore operation may comprise, for example, a logging operation performed an operation with a wireline tool 15, or the like. After having unspooled a specific length of cable 13 during the wellbore operation, the electrical motor 12 becomes an electrical generator, as will be appreciated by those skilled in the art.

During this phase, the electrical motor/generator 12 needs to be controlled. Indeed, in order to have a counter torque on the drum to maintain the load (which may include the weight of the cable 13, the weight of the tool 15 to tool string, and extra tension on the cable 13 induced by tough logging conditions (TLC)) an electrical load needs to be connected to the electric motor/generator 12. This electrical load may be a resistor 18, which receives power from the motor/generator 12 through a braking chopper 17 that modulates the voltage and thus the current sent from the variable speed drive 16 into the braking resistor 18. The system 10 (including the motor/generator 12 and the braking resistor 18) may be disposed in an enclosure 19 or the like that contains an explosive atmosphere.

The braking resistor 18 dissipates the electrical power received from the variable speed drive 16 and braking chopper 17 in the form of heat. To comply with the explosive atmosphere standards such as ATEX Zone II or the like, the braking resistor 18 needs to be cooled in order maintain a predetermined temperature such as, but not limited to, a maximum surface temperature. A cooling or heat dissipation system 20, best seen in FIG. 2, is therefore provided to remove heat from the resistor 18 and thereby from the explosive atmosphere in the enclosure 19. The system 20 comprises a cooling medium 22 that is in fluid communication with both the resistor 18 and a heat exchanger 24. The cooling medium 22 may be circulated between the resistor 18 and the heat exchanger 24 by a pump 26 or the like, as will be appreciated by those skilled in the art.

In an embodiment, the cooling medium 22 is a liquid, such as water, a glycol mixture, or the like, and the heat exchanger 24 is an air-cooled radiator including an electrically driven fan or the like, which exchanges the heat from the heat exchanger 24 into the atmosphere, allowing the system 10 to be compliant with explosive atmosphere standards. Alternatively, the cooling medium 22 may be a gas and the heat exchanger 24 may be a refrigeration unit or the like that cools the gas 22 prior to being routed by a cooling fan 26 to the resistor 18 and enclosure 19, as will be appreciated by those skilled in the art. The cooling system 20, including the cooling medium 22, the heat exchanger 24, and the pump/fan 26 may also be disposed in the enclosure 19 that contains the explosive atmosphere, with the exhaust air, for example, from the heat exchanger 24 being routed out of the enclosure 19. Those skilled in the art will appreciate that numerous types of cooling and/or refrigeration systems and devices may be utilized to remove heat from an electrical component, such as the resistor 18, while remaining within the scope of the present invention.

The system 20 preferably includes a control system (not shown) that controls the function of the pump 26 and the heat exchanger 24 to maintain the resistor 18 at a predetermined temperature. The control system may also be to shut down the system 10 in the event the predetermined temperature is exceeded. The resistor 18 may be provided with a suitable sensor or sensors (not shown) and the like to provide a signal or signals to the control system for acquisition and control purposes, as will be appreciated by those skilled in the art. In an embodiment, the predetermined temperature and/or installed sensor on the resistor 18 corresponds to maintain a surface temperature of the braking resistor 18 below the ignition point of any potential explosive substances. The predetermined temperature may, but it not limited to, correspond to standards such as ATEX standards or the like, such as ATEX Zone II. The system 20 may comprise other suitable sensors such as, but not limited to, a temperature sensor or atmospheric sensor for the enclosure 19, and temperature sensors for the motor generator 12, the variable speed drive 16, and the like.

An embodiment of the system 10 and/or apparatus may be advantageously utilized with an offshore wireline logging unit that is deployed in an enclosure comprising an explosive atmosphere (ATEX Zone II), which specify a maximum surface temperature of equipment, such as equipment in an enclosed area, such as the enclosure 19. Those skilled in the art will appreciate that embodiments of the system 10 or 20 may be utilized to meet many types of temperature controls in various configurations and/or industries.

The removal of heat from a braking resistor in electric/electronic fields is known such as, for example, systems comprising braking resistors that utilize the dissipated heat from the braking resistor to heat other elements of the system. Embodiments of the system 10 and 20, however, advantageously are utilized to remove heat from components disposed in explosive atmospheres.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values. Accordingly, the protection sought herein is as set forth in the claims below.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

What is claimed is:

1. A system to dissipate heat from electric equipment disposed in an explosive atmosphere, comprising:
at least one electric device disposed in an explosive atmosphere; and
a cooling system operable to remove heat from the at least one electric device to cool the at least one electric device to a predetermined temperature.

2. The system of claim 1 wherein the at least one electric device is an electric motor/generator coupled to a braking resistor.

3. The system of claim 2 wherein the electric motor/generator is coupled to a braking resistor via a variable speed drive and braking chopper.

4. The system of claim 1 wherein the cooling system comprises a cooling medium for removing heat from the electric device and a heat exchanger.

5. The system of claim 4 wherein the cooling medium comprises a liquid cooling system and the heat exchanger comprises an air-cooled radiator for cooling the liquid.

6. The system of claim 4 wherein the cooling medium comprises a gas cooling system and a refrigeration device for cooling the gas.

7. The system of claim 1 wherein the predetermined temperature is determined by an ignition point of at least one explosive substance.

8. The system of claim 1 wherein the predetermined temperature is a surface temperature of the electric device.

9. The system of claim 1 wherein the predetermined temperature is an ATEX Zone II temperature.

10. A system to dissipate heat from equipment in an explosive atmosphere, comprising:
at least one device generating a source of heat and disposed in an explosive atmosphere; and
a cooling system operable to remove heat from the at least one device such that an exterior surface of the at least one device is cooled to a predetermined temperature.

11. The system of claim 10 wherein the cooling system comprises a cooling medium for removing heat from the electric device and a heat exchanger.

12. The system of claim 11 wherein the cooling medium comprises a liquid cooling system and the heat exchanger comprises an air-cooled radiator for cooling the liquid.

13. The system of claim 11 wherein the cooling medium comprises a gas cooling system and a refrigeration device for cooling the gas.

14. The system of claim 10 wherein the predetermined temperature is determined by an ignition point of at least one explosive substance.

15. A system to dissipate heat from an electric winch drive for wellbore cables, the winch drive disposed in an explosive atmosphere, comprising:
an electric motor/generator in communication with a source of electrical power and a braking resistor coupled to the electric motor/generator, the motor/generator and the resistor disposed in an explosive atmosphere; and
a cooling system operable to remove heat from the braking resistor such that an exterior surface of the resistor is cooled to a predetermined temperature.

16. The system of claim 15 wherein the electric/motor generator is coupled to and controls a wireline winch having a wireline cable disposed thereon.

17. The system of claim 16 further comprising a tool attached to the wireline cable for performing at least one wellbore operation.

18. The system of claim 15 wherein the cooling system comprises a cooling medium for removing heat from the electric device and a heat exchanger.

19. The system of claim 18 wherein the cooling medium comprises a liquid cooling system and the heat exchanger comprises an air-cooled radiator for cooling the liquid.

20. The system of claim 18 wherein the cooling medium comprises a gas cooling system and a refrigeration device for cooling the gas.
